(19) United States
(12) Patent Application Publication
(10) Pub. No.: US 2010/0036605 A1
(43) Pub. Date: Feb. 11, 2010

(54) NAVIGATION SYSTEMS AND ROUTE PLANNING METHODS THEREOF

(75) Inventor: Ai-Chieh Lee, Taipei (TW)

Correspondence Address: QUINTERO LAW OFFICE, PC, 615 Hampton Dr, Suite A202, Venice, CA, 90291, US

(73) Assignee: MITAC INTERNATIONAL CORP., TAOYUAN (TW)

(21) Appl. No.: 12/332,836

(22) Filed: Dec. 11, 2008

(30) Foreign Application Priority Data
Aug. 7, 2008 (TW) 97130036

(51) Int. Cl. G01C 21/00

(52) U.S. Cl. 701/202

(57) ABSTRACT

Route planning methods for navigating an electronic device are disclosed. The method includes the following steps. First, the electronic device generates a planned route according to at least one destination, and performs a navigation process according to the planned route. It is determined whether a route re-planning request has been generated. When the route re-planning request has been generated, a return point is determined from the planned route, wherein the return point corresponds to a current position of the electronic device. A partial route from the current position to the return point is determined. Navigating to the return point is performed according to the partial route and the navigation process proceeds from the return point to the destination according to the planned route.

### CROSS REFERENCE TO RELATED APPLICATIONS

This Application claims priority of Taiwan Patent Application No. 097130036, filed on Aug. 7, 2008, the entirety of which is incorporated by reference herein.

### BACKGROUND OF THE INVENTION

1. Field of the Invention

The disclosure relates generally to route planning methods and related navigation systems, and, more particularly to route planning methods and related navigation systems that provide fast route re-planning.

2. Description of the Related Art

Global Positioning System (GPS) technology has been widely used in navigation systems of various electronic devices, such as portable devices and electronic devices in cars to receive signals from GPS satellites. Accordingly, the position of an electronic device with a GPS receiver therein, can be determined according to responsive positioning signals between the electronic device and the satellites. Users may also use navigation software in the electronic device for route planning and navigation.

Generally, when users desire to move from a starting point to a destination, the navigation software may plan a suggested route therebetween, according to a specific algorithm for guiding the users in a particular direction. Meanwhile, when users deviate from the calculated particular direction, a route re-planning process will be activated to plan a new route from the new position of the electronic device to the destination. The operation for the route re-planning process, however, has to consider various factors, such as distances between two points and the complexity of surrounding roads, such that the operation may be time consuming. In such a situation, before the route re-planning process is completed, users may have already traveled in a wrong direction and be lost.

It is therefore an important objective to shorten the calculation time for the route re-planning process.

### BRIEF SUMMARY OF THE INVENTION

Route planning methods and related navigation systems are provided.

In an embodiment of a route planning method for use in an electronic device, a planned route is generated according to at least one destination and a navigation process is performed according to the planned route by the electronic device. It is determined whether a route re-planning request has been generated. When the route re-planning request has been generated, a return point is determined from the planned route, wherein the return point corresponds to a current position of the electronic device. A partial route is re-planned from the current position to the return point. Navigating to the return point is performed according to the partial route and the navigation process proceeds from the return point to the destination according to the planned route.

An embodiment of a navigation system for use in an electronic device comprises a display unit, a processing unit and a determination unit. The processing unit acquires a current position of the electronic device and generates a planned route according to a destination, wherein the electronic device performs a navigation process according to the planned route. The determination unit determines a return point from the planned route, wherein the return point corresponds to the current position of the electronic device. The electronic device determines whether a route re-planning request has been generated, and re-plans a partial route from the current position to the return point, navigates to the return point according to the partial route and proceeds to the navigation process from the return point to the destination according to the planned route when the route re-planning request has been generated.

In another embodiment of a route planning method for use in an electronic device, a planned route is generated according to at least one destination and a navigation process is performed according to the planned route by the electronic device. It is determined whether a route re-planning request has been generated. When the route re-planning request has been generated, a return point that is a nearest point to a current position of the electronic device is determined from the planned route. A partial route from the current position to the return point is re-planned and the planned route is reserved. Navigating to the return point is performed according to the partial route and the navigation process from the return point to the destination proceeds according to the planned route, wherein the partial route is a shortest route or a fastest route from the current position to the planned route.

Route planning methods and navigation systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a navigation system of the invention;

FIG. 2A is a schematic diagram illustrating an embodiment of a route planning result of the invention;

FIG. 2B is a schematic diagram illustrating another embodiment of a route planning result of the invention;

FIG. 2C is a schematic diagram illustrating yet another embodiment of a route planning result of the invention; and

FIG. 3 is a flowchart of an embodiment of a route planning method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide navigation systems and related route planning methods for use in an electronic device such that when a route re-planning request has been generated and the electronic device has moved to a path or a direction that has deviated from an original planned route, a return point of the original planned route is determined to return to the original planned route, thereby quickly completing the route re-planning process and reducing the calculation time for the route re-planning process.

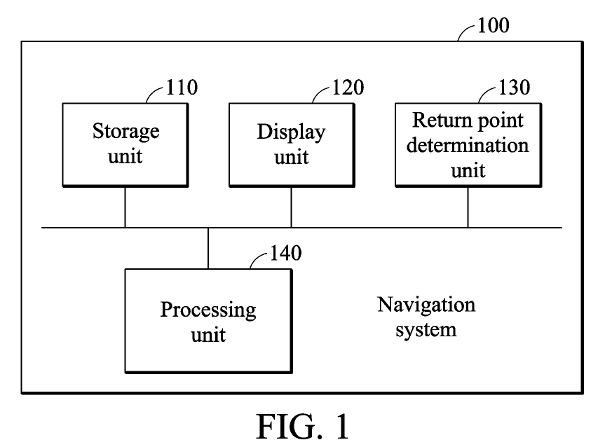

FIG. 1 is a schematic diagram illustrating an embodiment of a navigation system of the invention. The navigation system is suitable for use in an electronic device, such as a computer system or a portable device having a navigation function.

The navigation system 100 comprises a storage unit 110, a display unit 120, a route planning unit 130 and a processing unit 140. The storage unit 110 comprises map data corresponding to at least one specific region, such as an area or a country. The map data may comprise doorplate addresses, landmarks, scenic spots, and/or road and information thereof. The display unit 120 displays related data, such as a user interface, route planning results, and related navigation information. The processing unit 140 may be a navigation engine having a route planning capability. Users may input navigation parameters, such as a starting point, a destination, and/or at least one mid-point via the user interface. The processing unit 140 performs route planning according to the navigation parameters such as the starting point, the mid-point and the destination to obtain at least one route planning result. Users may be navigated to the destination according to a planned route which is obtained by the route planning result. It is noted that, the navigation system 100 may further comprise a signal receiving unit (not shown) to receive satellite signals. The processing unit 140 may then calculate a current position of the electronic device based on the received signals. When the current position of the electronic device conforms to the route planning result (i.e. the planned route), the processing unit 140 may proceed to provide the navigation function to move the electronic device to the destination according to the original route planning result. When the current position of the electronic device does not conform to or has deviated from the route planning result, the processing unit 140 may perform the route planning method of the invention to re-plan the route planning. Description of the route planning method of the invention is detailed below. The return point determination unit 130 determines a return point according to a specific rule to assist the processing unit 140 in route re-planning. When the current position of the electronic device has deviated from the original planned route, the return point determination unit 130 first determines the return point and the processing unit 140 and then re-plans the route planning based on the determined return point.

The return point may be a point which is selected from the original planned route, and may be related to the current position of the electronic device. In addition, the return point may be close to the current position in which the position may be set based on the specific rule. It is noted that, the specific rule for the return point may be pre-determined and stored in the storage unit 110 so that the return point determination unit 130 can automatically determine a suitable return point based on the specific rule when a route re-planning request has been generated.

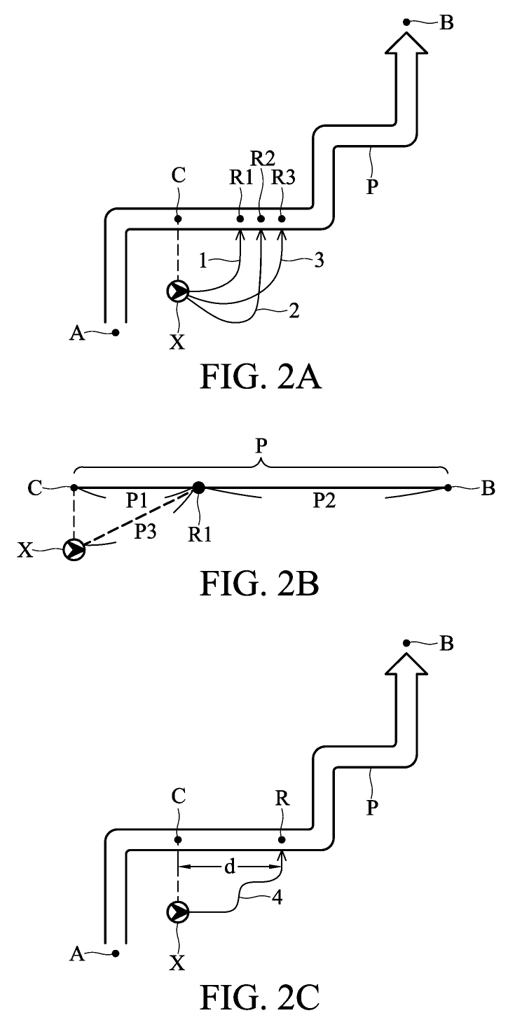

In some embodiments, the specific rule may relate to, for example but not limited thereto, a shortest route and determination of the return point from the planned route may be performed by finding the shortest route between the current position and the planned route and setting a point that corresponds to the shortest route in the planned route to be the return point. In some embodiments, the specific rule may relate to a fastest route and determination of the return point from the planned route may be performed by finding the fastest route between the current position and the planned route and setting a point that corresponds to the fastest route in the planned route to be the return point. For example, please refer to FIGS. 2A and 2B.

FIGS. 2A and 2B are schematic diagrams illustrating embodiments of route planning results of the invention. As shown in FIG. 2A, the display unit 120 displays a planned route P from a starting point A to the destination B in which symbol X represents a current position of the electronic device and symbol C represents a mid-point with the correct position that the electronic device is navigated to. Symbols 1, 2 and 3 respectively represent three possible routes from the current position X to the original planned route and symbols R1, R2 and R3 respectively represent return points corresponding to the three possible routes 1, 2 and 3. In this embodiment, for example, the mid-point C is the next intersection of the current position X. Therefore, the electronic device may have multiple possible moving directions while it is moving through the mid-point C. As shown in FIG. 2A, it is observed from the current position X that the position of the electronic device has deviated from the original planned route and thus route re-planning is required. It is assumed that the route 1 represents the shortest route while the route 3 represents the fastest route from the current position X to the planned route. In this case, the return point determination unit 130 may determine the R1 or R3 to be the return point according to whether the set specific rule corresponds to the shortest route or the fastest route.

Release refers to FIG. 2B, which is a schematic diagram illustrating a route planning result corresponding to FIG. 2A. As shown in FIG. 2B, it is assumed that the symbol R1 represents the determined return point and the planned route P is divided into one route P1 from the mid-point C to the return point R1 and another route P2 from the return point R1 to the destination B. When the current position of the electronic device has deviated from the original planned route P while it is moving through the mid-point C, a route re-planning request is generated. The return point determination unit 130 then determines the point R1 to be the return point and the processing unit 140 re-plans a corresponding route P3 from the current position X to the return point R1 accordingly. Thereafter, navigating to the return point is performed according to the new planned route P3. The navigation process therefore proceeds from the return point R1 to the destination B according to the original planned route P2 when the return point R1 has been reached.

Because the route P2 may be pre-planned, no route re-planning is required, thereby improving speed of the route re-planning process and reducing required time.

Similarly, in some embodiments, users may configure a predetermined distance within the originally planned route via a user interface. For example, a user may configure a mid-point that is several kilometers or hundred meters from the current position in the original planned route to be the return point so as to assist in route re-planning.

FIG. 2C shows a schematic diagram illustrating another route planning result of the invention. As shown in FIG. 2C, it is assumed that users may configure a mid-point R that has a distance d in front of the current position X to be the return point and thus route re-planning is performed to generate a corresponding route 4 from the current position X to the mid-point R for navigation. In addition, in some embodiments, the length d of the predetermined distance may be dynamically adjusted based on the remaining length of the planned route (i.e. distance to the destination that is remaining). In such a situation, users may only require to configure the predetermined distance by inputting a number of the predetermined distance in unit length. For example, it is assumed that the number of the predetermined distance d is set to be 2. When the length of the remaining distance is about one hundred kilometers, one kilometer may serve as the unit length so that a point that has a distance 2 kilometers in front of the current position will be set as the return point. When the length of the remaining distance is reduced to about fifty kilometers, the unit length is automatically adjusted to a half of one kilometer so that a point that has a distance 1 kilometer in front of the current position will be set as the return point. It is to be understood that the return point may be determined by, for example, finding a mid-point nearest to the current position or selecting one mid-point that is in front of and nearest to the current position from a default group having multiple mid-points, but it is not limited thereto.

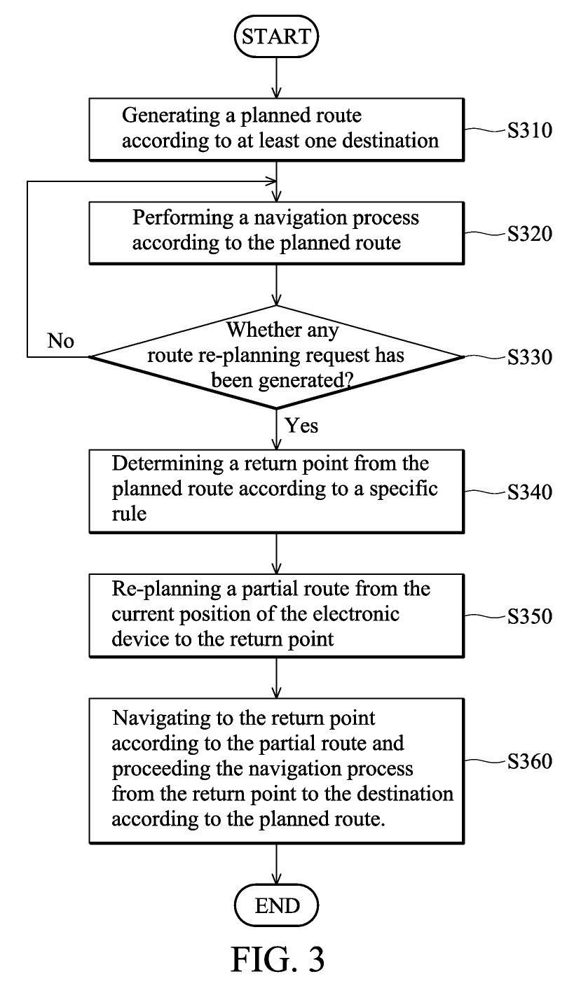

FIG. 3 is a flowchart of an embodiment of a route planning method of the invention. The route planning method is suitable for use in an electronic device, such as a computer system or a portable device having a navigation function.

In step S310, a planned route P is generated according to a destination set by the user. In step S320, a navigation process is performed according to the planned route. It is understood that, during the navigation process, the electronic device will continually receive satellite signals, and calculate the current position of the electronic device according to the satellite signals. It is then determined, in step S330, whether any route re-planning request has been generated. The determination of whether a route re-planning request has been generated is performed by determining whether the electronic device is moving in accordance with the planned route. When the electronic device is not moving in accordance with the planned route, it is determined that deviation from the original route has occurred and route re-planning is performed generating a route re-planning request. If no route re-planning request has been generated (No in step S330), the procedure returns to step S320, and the navigation process proceeds according to the planned route P, and then the step S330 is re-performed to determine whether any route re-planning request has been generated again. If a route re-planning request has been generated (Yes in step S330), in step S340, a return point from the planned route is determined according to a specific rule. Similarly, in some embodiments, the specific rule may, for example be related to a shortest route, a fastest route or a predetermined distance, and determination of the return point from the planned route is performed by finding the shortest route, the fastest route or the predetermined distance between the current position and the planned route and a mid-point that corresponds to the shortest route, the fastest route or the predetermined distance respectively is set in the planned route to be the return point, but is not limited thereto. In some embodiments, the specific rule may relate to a fastest route and determination of the return point from the planned route is performed by finding the fastest route between the current position and the planned route and setting a point that corresponds to the fastest route in the planned route to be the return point. It is also noted that the length of the predetermined distance may be dynamically adjusted based on the remaining length of the planned route (i.e. distance remained to the destination). It is further noted that the specific rule for the return point may be pre-determined and stored in the storage unit 110 so that the return point determination unit 130 can automatically determine a suitable return point based on the specific rule when a route re-planning request has been generated.

When the return point is determined, in step S350, a partial route is re-planned according to the current position of the electronic device. The partial route is a new planned route from the current position of the electronic device to the return point. Meanwhile, the remained original planned route P from the return point to the destination will be reserved. Therefore, in step S360, navigating to the return point is performed according to the partial route and the navigation process proceeds from the return point to the destination according to the reserved original planned route.

For example, please refer again to FIG. 2A. It is assumed that the return point is determined by finding the shortest route between the current position and the planned route. As described, it is observed from the current position X that the position of the electronic device has deviated from the original planned route P and thus a route re-planning request has been generated to perform route re-planning. Accordingly, the point R1 is determined to be the return point according to the shortest route requirement. Thereafter, a corresponding partial route 1 from the current position X to the return point R1 is re-planned. Thus, navigating to the return point is performed to the electronic device according to the new planned partial route 1 and, after the return point R1 has been reached, the navigation process proceeds from the return point R1 to the destination B according to the original planned route P.

In summary, according to the navigation system and related route planning method of the invention, when a route re-planning request has been generated, it may simply determine a return point in front of the current position of the electronic device in the planned route and re-plan a route from the current position to the return point to return to the original planned route so as to use the remained original planned route to proceed the navigation process to move the electronic device to the destination. Due to the return point is close to the mid-point planned by the original planned route, the needed time for route re-planning can be significantly reduced. Even if users are deviated from the original planned route, a new replacement route can be quickly generated so that users may be able to response it quickly and know that what direction should be going forward, efficiently improving the route re-planning performance and response speed thereof. Furthermore, since the route re-planning process is only aimed at a partial route that may have a shorter length, the time and calculation needed for the route re-planning process may be significantly reduced.

Navigation systems and route planning method thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A route planning method for use in an electronic device, comprising:
generating a planned route according to at least one destination by the electronic device;
performing a navigation process according to the planned route by the electronic device;
determining whether a route re-planning request has been generated;
determining a return point from the planned route when the route re-planning request has been generated, wherein the return point corresponds to a current position of the electronic device;
re-planning a partial route from the current position to the return point; and
navigating to the return point according to the partial route and proceeding with the navigation process from the return point to the destination according to the planned route.

2. The route planning method of claim 1, wherein the determination of whether the route re-planning request has been generated is performed by determining whether the electronic device has moved toward the destination based on the planned route.

3. The route planning method of claim 1, wherein the step of determining the return point from the planned route further comprises:
determining a position of the return point according to a specific rule.

4. The route planning method of claim 3, wherein the specific rule is related to a shortest route and the step of determining the return point from the planned route further comprises:
finding the shortest route between the current position and the planned route; and
setting a point that corresponds to the shortest route in the planned route to be the return point.

5. The route planning method of claim 3, wherein the specific rule is related to a fastest route and the step of determining the return point from the planned route further comprises:
finding the fastest route between the current position and the planned route; and
setting a point that corresponds to the fastest route in the planned route to be the return point.

6. The route planning method of claim 3, wherein the specific rule is related to a predetermined distance and the step of determining the return point from the planned route further comprises:
setting a point that corresponds to the predetermined distance in the planned route to be the return point.

7. The route planning method of claim 6, wherein the predetermined distance is configured by a user via a user interface.

8. The route planning method of claim 6, wherein the length of the predetermined distance is dynamically adjusted based on the remaining length of the planned route.

9. A navigation system for use in an electronic device, comprising:
a display unit;
a processing unit, acquiring a current position of the electronic device and generating a planned route according to a destination, wherein the electronic device performs a navigation process according to the planned route; and
a determination unit, determining a return point from the planned route, wherein the return point corresponds to the current position of the electronic device,
wherein the electronic device determines whether a route re-planning request has been generated, and re-plans a partial route from the current position to the return point, navigates to the return point according to the partial route and proceeds to the navigation process from the return point to the destination according to the planned route when the route re-planning request has been generated.

10. The navigation system of claim 9, wherein the processing unit further determines whether the route re-planning request has been generated by determining whether the electronic device has moved toward the destination based on the planned route.

11. The navigation system of claim 9, wherein the processing unit further determines a position of the return point according to a specific rule.

12. The navigation system of claim 11, wherein the specific rule is related to a shortest route and the determination unit further finds the shortest route between the current position and the planned route and sets a point that corresponds to the shortest route in the planned route to be the return point.

13. The navigation system of claim 11, wherein the specific rule is related to a fastest route and the determination unit further finds the fastest route between the current position and the planned route and sets a point that corresponds to the fastest route in the planned route to be the return point.

14. The navigation system of claim 11, wherein the specific rule is related to a predetermined distance and the determination unit, for the step of determining the return point from the planned route, further sets a point that corresponds to the predetermined distance in the planned route to be the return point,.

15. The navigation system of claim 14, wherein the predetermined distance is configured by a user via a user interface.

16. The navigation system of claim 14, wherein the length of the predetermined distance is dynamically adjusted based on the remaining length of the planned route.

17. A route planning method for use in an electronic device, comprising:
generating a planned route according to at least one destination by the electronic device;
performing a navigation process according to the planned route by the electronic device;
determining whether a route re-planning request has been generated;
determining a return point that is a nearest point to a current position of the electronic device from the planned route when the route re-planning request has been generated;
re-planning a partial route from the current position to the return point and reserving the planned route; and
navigating to the return point according to the partial route and proceeding with the navigation process from the return point to the destination according to the planned route,
wherein the partial route is a shortest route or a fastest route from the current position to the planned route.

18. A machine-readable storage medium comprising a computer program, which, when executed, causes a device to perform a route planning method, and the method comprising:
generating a planned route, wherein the device performs a navigation process according to the planned route;
determining whether a route re-planning request has been generated;
determining a return point from the planned route when the route re-planning request has been generated, wherein the return point corresponds to a current position of the electronic device;
re-planning a partial route from the current position to the return point; and
navigating to the return point according to the partial route and proceeding with the navigation process from the return point according to the planned route.
